(19) United States
(12) Patent Application Publication
(10) Pub. No.: US 2017/0160675 A1
(43) Pub. Date: Jun. 8, 2017

(54) DEVELOPING DEVICE, PROCESS CARTRIDGE, AND IMAGE FORMING APPARATUS INCORPORATING SAME

(71) Applicant: Sayuri Katoh, Tokyo (JP)

(72) Inventors: Ichiro KADOTA, Kanagawa (JP); Shinji TAMAKI, Tokyo (JP); Keiichi YOSHIDA, Kanagawa (JP); Hiroshi HOSOKAWA, Kanagawa (JP); Shunji KATOH, Kanagawa (JP)

(73) Assignee: Ricoh Company, Ltd., Tokyo (JP)

(21) Appl. No.: 15/341,272

(22) Filed: Nov. 2, 2016

(30) Foreign Application Priority Data
Dec. 4, 2015 (JP) 2015-237462

(51) Int. Cl. G03G 15/09

(52) U.S. Cl. CPC G03G 15/0921; G03G 21/18

(57) ABSTRACT

A developing device includes a developer bearer to bear developer, a developer containing compartment to contain developer, and a developer conveyor including a shaft and disposed in the developer containing compartment. The developer bearer has magnetic poles adjacent to each other and identical in polarity, and the adjacent magnetic poles are disposed on a downward-rotation side where a surface of the developer bearer moves downward. The developer conveyor rotates to supply the developer to the surface of the developer bearer and collect the developer downstream, in a rotation direction of the developer bearer, from a developing range opposing a latent image bearer. The developing device further includes an inclined face disposed vertically below the adjacent magnetic poles, and the inclined face is inclined down toward the developer conveyor.

### CROSS-REFERENCE TO RELATED APPLICATIONS

This patent application is based on and claims priority pursuant to 35 U.S.C. §119(a) to Japanese Patent Application No. 2015-237462, filed on Dec. 4, 2015, in the Japan Patent Office, the entire disclosure of which is hereby incorporated by reference herein.

### BACKGROUND

Technical Field

Embodiments of the present invention generally relate to a developing device, a process cartridge, and an image forming apparatus, such as a copier, a printer, a facsimile machine, or a multifunction peripheral (MFP) having at least two of copying, printing, facsimile transmission, plotting, and scanning capabilities.

Description of the Related Art

There are developing devices that include a developer containing compartment to contain two-component developer including magnetic carrier and toner and a developer bearer containing a magnetic field generator. The magnetic field generator exerts a magnetic force to attract the two-component developer onto the surface of the developer bearer, and the developer bearer transports the developer to a developing range facing a latent image bearer.

For example, the developer containing compartment is disposed lower than the developer bearer (e.g., a developing roller), and a conveying screw to stir and transport developer is disposed in the developer containing compartment. The developer bearer has multiple magnetic poles, among which is a developer scooping pole to attract the developer. The developer in the developer containing compartment is borne on the developer bearer due to the rotation of the conveying screw and the developer scooping pole. As the developer bearer rotates, the developer is transported to the developing range, where the toner in the developer adheres to an electrostatic latent image on the latent image bearer (e.g., a photoconductor drum). Downstream from the developing range in the direction of rotation of the developer bearer, the developer bearer has two magnetic poles adjacent to each other and identical in polarity. The two magnetic poles generate a developer release range therebetween to separate the developer from the developer bearer. The developer separated from the developer bearer falls to the developer containing compartment and mixed in the developer therein.

### SUMMARY

An embodiment of the present invention provides a developing device that includes a developer bearer to bear developer, a developer containing compartment to contain developer, and a developer conveyor including a shaft and disposed in the developer containing compartment. The developer bearer has magnetic poles adjacent to each other and identical in polarity, and the adjacent magnetic poles are disposed on a downward-rotation side where a surface of the developer bearer moves downward. The developer conveyor rotates to supply the developer to the surface of the developer bearer and collect the developer downstream, in a rotation direction of the developer bearer, from a developing range opposing a latent image bearer. The developing device further includes an inclined face disposed vertically below the adjacent magnetic poles, and the inclined face is inclined down toward the developer conveyor.

Another embodiment provides a process cartridge to be removably mounted in an image forming apparatus. The process cartridge includes a latent image bearer to bear a latent image, the above-described developing device to develop the latent image with the developer, and a frame to support the latent image bearer and the developing device as a unit.

Yet another embodiment provides an image forming apparatus that includes the latent image bearer and the above-described developing device.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of an image forming apparatus according to an embodiment;

FIG. 2A is a perspective view of a process cartridge of the image forming apparatus illustrated in FIG. 1;

FIG. 2B is a cross-sectional view of the process cartridge;

FIG. 3 is a perspective view illustrating an exterior of a developing device according to an embodiment;

FIGS. 4A and 4B are perspective views of the developing device illustrated in FIG. 3, divided into an upper casing and a lower casing to illustrate an interior of a developer containing compartment;

FIG. 5 is a schematic diagram illustrating a circulation passage of developer in the developing device illustrated in FIG. 3;

FIG. 6 is a schematic cross-sectional view of the developing;

FIG. 7 is another schematic cross-sectional view of the developing device, together with developer contained therein;

FIG. 8 is a partial cross-sectional view illustrating an arrangement of a developing roller and a second conveying screw according to an embodiment;

FIG. 9 is a partial cross-sectional view illustrating an arrangement of the developing roller and the second conveying screw according to Comparative Example 1;

FIG. 10 is a partial cross-sectional view illustrating an arrangement of the developing roller and the second conveying screw according to Comparative example 2; and

FIG. 11 is a partial cross-sectional view illustrating an arrangement of the developing roller and the second conveying screw according to Comparative example 3.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to he limited to the specific terminology so selected, and it is to be understood that each specific element includes all technical equivalents that operate in a similar manner and achieve a similar result.

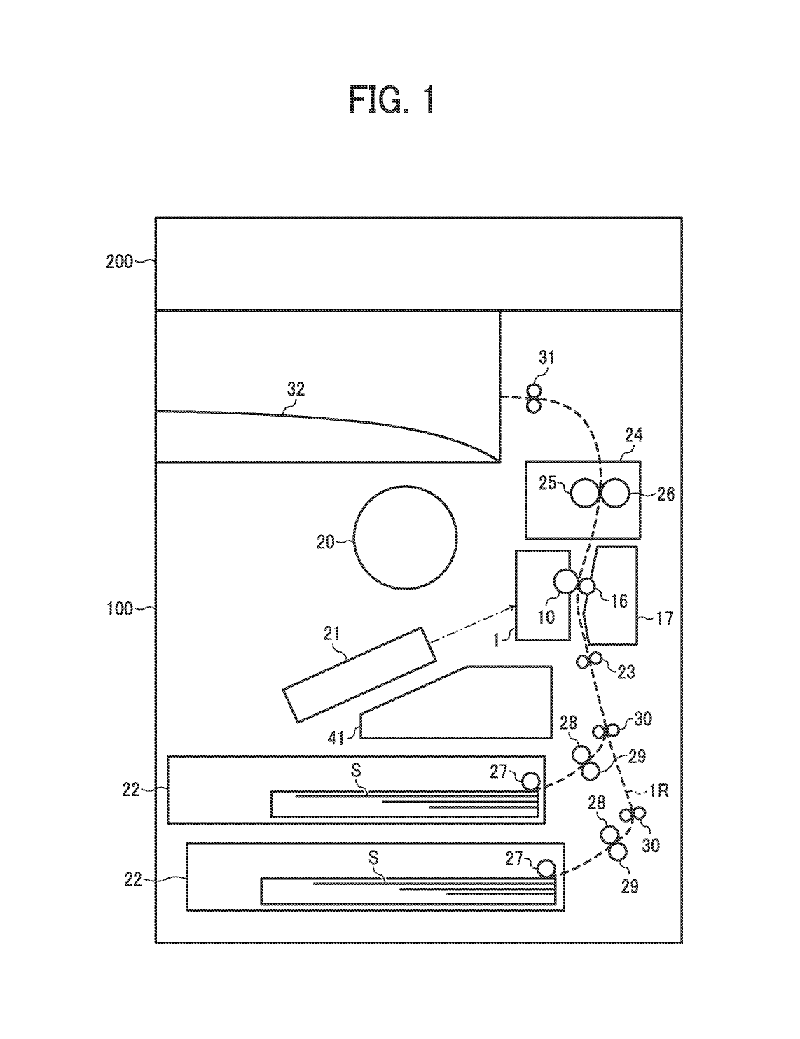

Referring now to the drawings, wherein like reference numerals designate identical or corresponding parts throughout the several views thereof, and particularly to FIG. 1, an image forming apparatus according to an embodiment of the present invention is described.

FIG. 1 is a schematic view of an image forming apparatus according to an embodiment.

For example, an image forming apparatus 500 illustrated in FIG. 1 is a copier and includes a scanner 200 (i.e., an image reading device) disposed above an apparatus body 100. The apparatus body 100 contains a process cartridge 1.

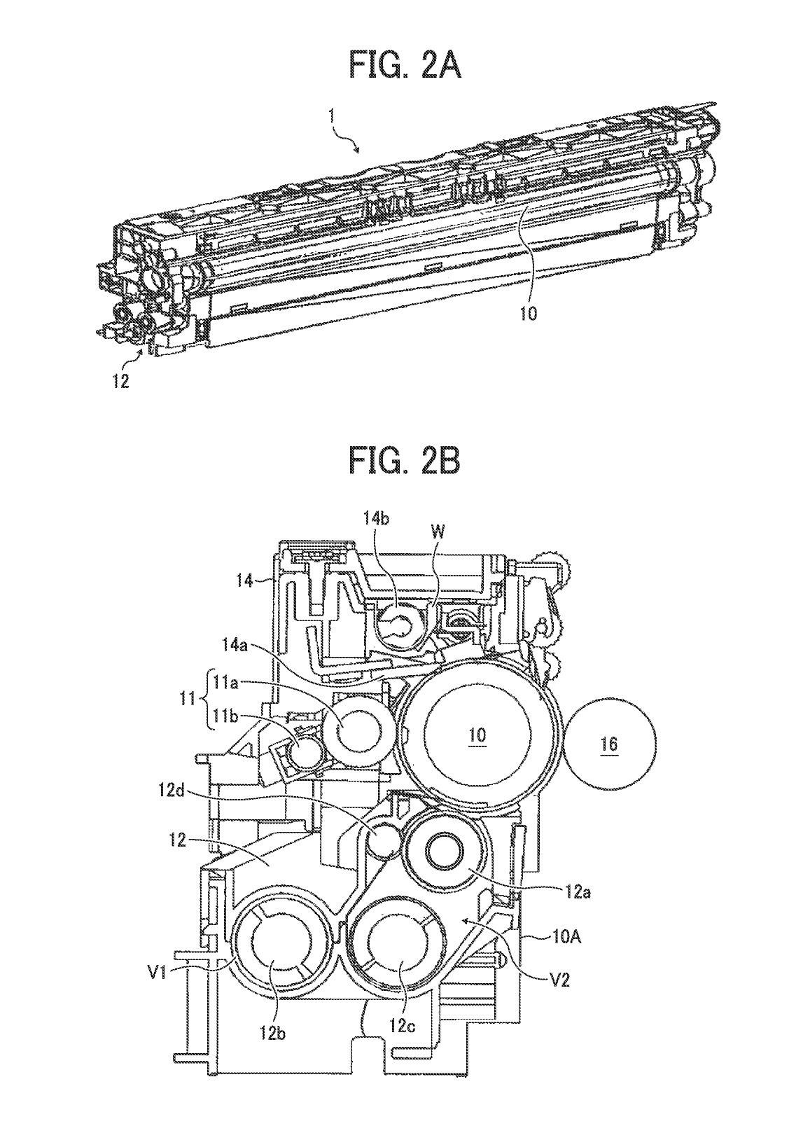

FIG. 2A is a perspective view of the process cartridge 1, and FIG. 2B is a cross-sectional view of the process cartridge 1.

As illustrated in FIG. 2B, the process cartridge 1 includes a photoconductor 10 serving as a latent image bearer. Around the photoconductor 10, devices to execute image forming processes on the photoconductor 10, namely, a charging device 11, a developing device 12, a cleaning device 14, and the like are disposed. The process cartridge 1 includes a frame 10A to support the components of the process cartridge 1 as a unit. The process cartridge 1 is removably mountable in the apparatus body 100. When the photoconductor 10, the charging device 11, the developing device 12, and the cleaning device 14 are united into the process cartridge 1, replacement work and maintenance work can be easier. Additionally, in the process cartridge 1, the relative positions of the components can be kept at a higher degree of accuracy, thus enhancing the quality of images produced.

The charging device 11 (i.e., a charger) includes a charging roller 11a and a removing roller 11b. A charging bias is applied to the charging roller 11a, and the charging roller 11a gives electrical charges to the surface of the photoconductor 10 to uniformly charge the photoconductor 10, The removing roller 11b removes substances, such as toner, adhering to the surface of the charging roller 11a.

The developing device 12 includes a first developer compartment V1 (a developer containing compartment), in which a first conveying screw 12b serving as a developer conveyor is disposed, and a second developer compartment V2. In the second developer compartment V2, a second conveying screw 12c serving as another developer conveyor, a developing roller 12a serving as a developer bearer, and a developer doctor 12d serving as a developer regulator are disposed.

The first and second developer compartments V1 and V2 contain two-component developer including magnetic carrier and negatively charged toner. Being rotated by a driver, the first conveying screw 12b transports the developer inside the first developer compartment V1 to the front side of the paper on which FIG. 2B is drawn. At the end of the first developer compartment V1 on the front side of the paper on which FIG. 2B is drawn, the developer transported by the first conveying screw 12b enters the second developer compartment V2.

Being rotated by the driver, the second conveying screw 12c inside the second developer compartment V2 transports the developer to the back side of the paper on which FIG. 2B is drawn. Above the second conveying screw 12c in FIG. 2B, the developing roller 12a (the developer bearer) is disposed in parallel to the second conveying screw 12c. The developing roller 12a includes a nonmagnetic developing sleeve 12a2 (illustrated in FIG. 6) that rotates and a stationary magnet roller 12a1 disposed inside the developing sleeve 12a2, The magnet roller 12a1 serves as a magnetic field generator.

A portion of the developer transported by the second conveying screw 12c is scooped onto the surface of the developing roller 12a due to the rotation force of the second conveying screw 12c and the magnetic force exerted by the magnet roller 12a1. The developer doctor 12d is rod-shaped. and disposed across a predetermined gap from the surface of the developing roller 12a. The developer doctor 12d adjusts the thickness of a layer of developer borne on the developing roller 12a. Subsequently, the developer is transported to the developing range opposing the photoconductor 10, and the toner in the developer adheres to an electrostatic latent image on the photoconductor 10. Thus, a toner image is formed on the photoconductor 10. After the toner therein is thus consumed, the developer is returned to the second conveying screw 12c as the developing roller 12a rotates. The developer transported to the end of the second developer compartment V2 by the second conveying screw 12c is returned to the first developer compartment V1. Thus, the developer is circulated inside the developing device 12.

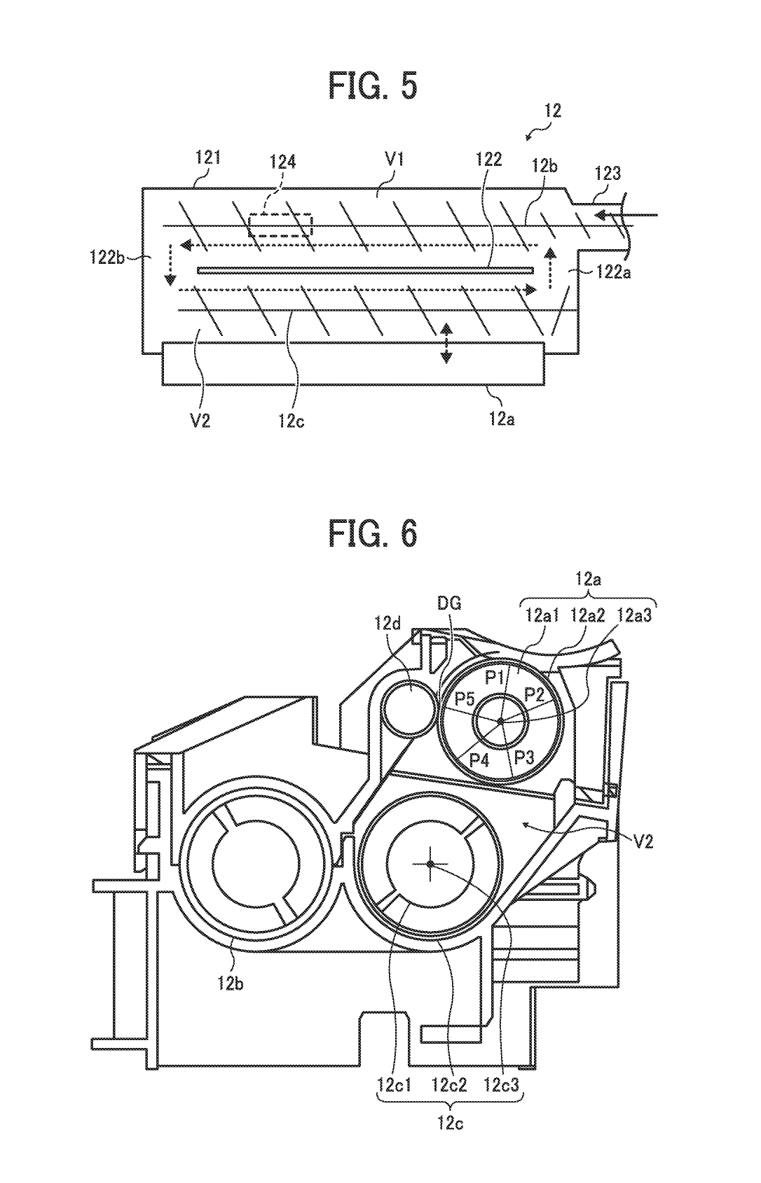

The developing device 12 further includes a toner concentration sensor 124 (illustrated in FIG. 5) serving as a toner concentration detector to detect the content (or percentage) of toner in developer, disposed in or on the bottom of the first developer compartment V1. For example, the toner concentration sensor 124 measures the toner concentration based on the magnetic permeability of the developer. As the toner concentration decreases, the magnetic carrier becomes denser, and the magnetic permeability increases. When a value detected by the toner concentration sensor 124 deviates from a target value (threshold), toner is supplied from a toner bottle 20 (illustrated in FIG. 1), serving as a toner container, to the developing device 12 to keep the toner concentration constant or substantially constant. For the target value, a toner pattern (a reference pattern) is formed on the photoconductor 10, and an optical sensor detects the amount of toner adhering to the toner pattern. The target value is determined based on the detected toner adhesion amount.

Although this operation is performed to keep the density (image density) of the reference pattern on the photoconductor 10 constant, decreases in the density of the reference pattern are inevitable when the toner bottle 20 becomes empty. In such a situation, even if the operation to supply the toner from the toner bottle 20 is executed for a certain length of time, the toner adhesion amount of the toner pattern, detected by the optical sensor, does not recover. Accordingly, in a case where the toner adhesion amount of the toner pattern, detected by the optical sensor, does not recover despite the operation to supply the toner from the toner bottle 20, a controller of the image forming apparatus 500 determines (or estimates) that there is no toner (toner end).

After the toner bottle 20 is replaced in response to the determination of “toner end”, the following operation is executed to supply toner from the toner bottle 2.0 to the developing device 12. The developing roller 12a and the first and second conveying screws 12b and 12c are rotated to mix the supplied toner with the developer. At that time, to prevent uneven sliding of the developer borne on the developing roller 12a, the photoconductor 10 is rotated.

The cleaning device 14 includes a cleaning blade 14a that contacts or abuts against the photoconductor 10 to scrape off the toner adhering to the photoconductor 10 after a transfer process. The toner collected by the cleaning blade 14a is stored in a collected toner compartment W, and the collected toner compartment W includes a toner collecting coil 14b to transport the collected toner. The collected toner is further transported by a toner conveyance device to the developing device 12. Alternatively, the collected toner can be transported to a waste-toner bottle 41. Yet alternatively, the collected toner can be transported to either the developing device 12 or the waste-toner bottle 41 depending on the degree of deterioration of the developer.

A transfer device 17 illustrated in FIG. 1 includes a transfer roller 16 pressed to the surface of the photoconductor 10. Disposed above the transfer device 17 is a thermal fixing device 24, which includes a heating roller 25 and a pressure roller 26. The apparatus body 100 further contains a laser writing device 21 serving as a latent image forming device. The laser writing device 21 includes a laser light source, a polygon mirror for scanning, a polygon motor, an fθ lens, and the like. The apparatus body 100 further contains sheet trays 22 stacked one on another, to store sheets S of recording media such as paper and overhead projector (OHP) transparencies.

To make copies using the image forming apparatus 500 configured as described above, when a user presses a start button, the scanner 200 reads the contents of the document set therein. Simultaneously, a photoconductor driving motor drives the photoconductor 10, and the charging device 11 including the charging roller 11a uniformly charges the surface of the photoconductor 10. Subsequently, the laser writing device 21 emits a laser beam according to the contents of the document scanned by the scanner 200, thus writing an electrostatic latent image on the photoconductor 10. The developing device 12 supplies the toner to the photoconductor 10, thereby developing the electrostatic latent image into a visible image.

When the user presses the start button, a pickup roller 27 sends out the sheet S from the selected sheet tray 22. One sheet S is separated from the rest by a sheet feeding roller 28 and a separation roller 29 and fed to a feeding path 1R. In the feeding path 1R, multiple conveyance roller pairs 30 transport the sheet S, and the sheet S is caught in a registration roller pair 23. The registration roller pair 23 forwards the sheet S to a transfer nip, where the transfer roller 16 contacts the photoconductor 10, timed to coincide with the arrival of the toner image on the photoconductor 10.

In the transfer nip, the transfer device 17 transfers the toner image onto the sheet S from the photoconductor 10. The cleaning device 14 removes the toner remaining on the photoconductor 10 after the image transfer, and a discharger removes residual potentials from the photoconductor 10. Then, the apparatus is prepared for subsequent image formation started by the charging device 11.

Meanwhile, the sheet S is guided to the fixing device 24. While passing between the heating roller 25 and the pressure roller 26, the sheet S is heated and pressed to fix the toner image on the sheet S. Subsequently, an ejection roller pair 31 discharges the sheet S to a sheet stack section 32.

Next, a configuration and operation of the developing device 12 is described in further detail below.

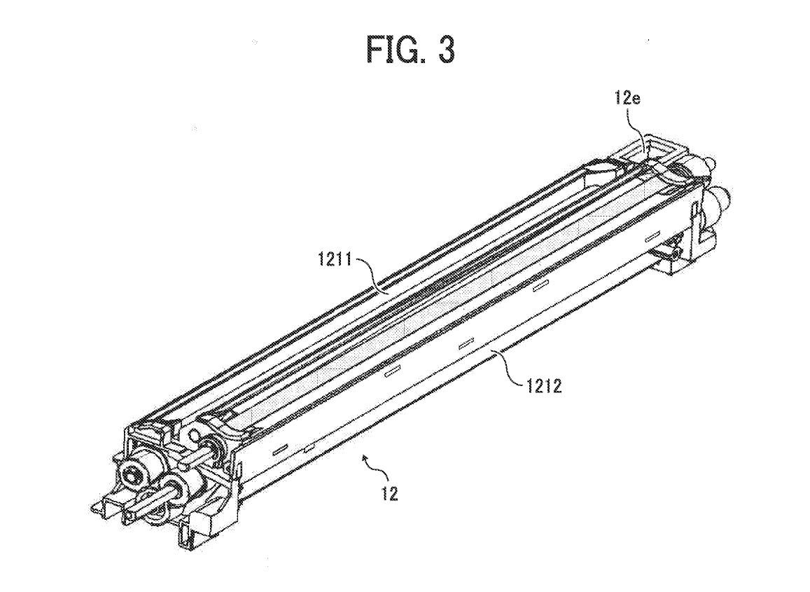

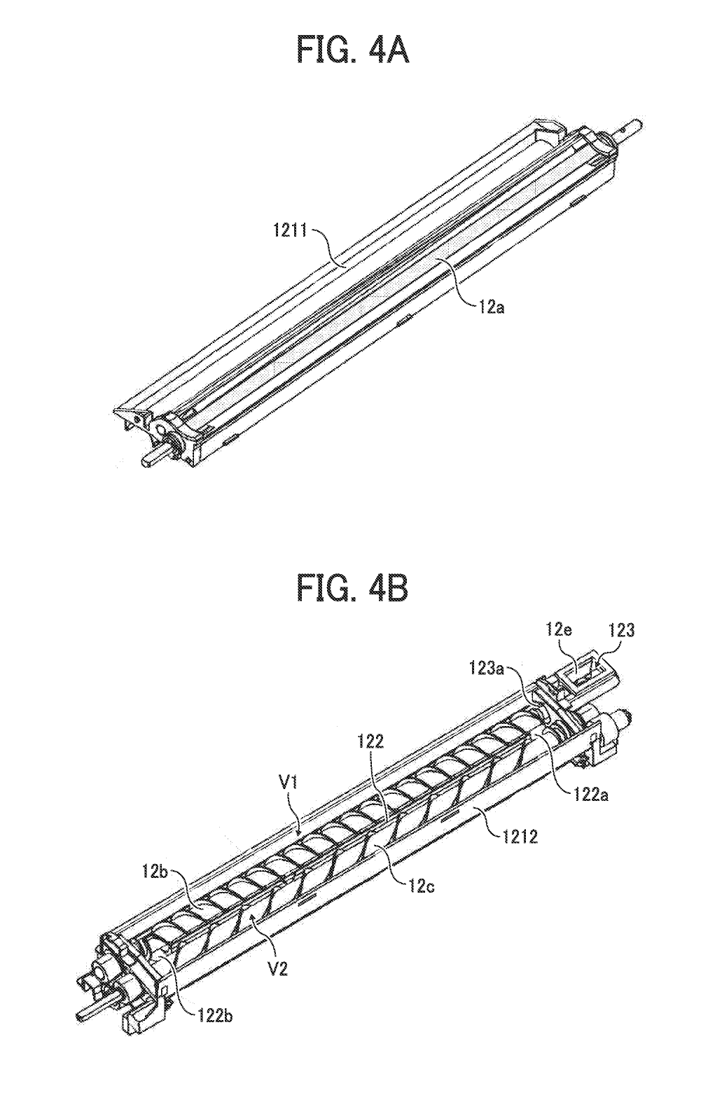

FIG. 3 is a perspective view illustrating an exterior of the developing device 12. FIGS. 4A and 4B are perspective views of the developing device 12 divided into an upper casing 1211 and a lower casing 1212 to illustrate an interior of the developer containing compartment. The upper casing 1211 and the lower casing 1212 together form a developing device casing 121 (illustrated in FIG. 5). FIG. 5 is a schematic diagram illustrating a circulation passage of the developer in the developing device 12. In FIG. 5, broken lines represent the flow of the developer, and solid lines represent the flow of the toner supplied from a toner supply inlet 12e.

As illustrated in FIG. 4A, the developing roller 12a is rotatably supported by the upper casing 1211. The developer doctor 12d, which is rod-shaped, fits in holes 1211a (illustrated in FIG. 4A) in side walls of the upper casing 1211 at both ends in the longitudinal direction of the developing device 12 (an axial direction of the developing roller 12a).

The lower casing 1212 defines the developer containing compartment inside the developing device 12. A partition 122 divides the developer containing compartment into the first developer compartment V1 and the second developer compartment V2. The first and second conveying screws 12b and 12c are disposed in the first and second developer compartments V1 and V2, respectively. The lower casing 1212 supports the first and second conveying screws 12b and 12c rotatably. The first developer compartment V1 communicates with the first developer compartment V1 through openings 122a and 122b located at ends of the partition 122.

At the downstream end of the second developer compartment V2 in the direction in which the second conveying screw 12c transports the developer, the developer moves to the first developer compartment V1, through the opening 122a at the end of the partition 122. Inside the first developer compartment V1, while stirring the developer, the first conveying screw 12b transports the developer in the direction opposite the direction in which the developer moves inside the second developer compartment V2. At the downstream end of the first developer compartment V1 in the direction in which the first conveying screw 12b transports the developer, the developer moves through the opening 122b to the second developer compartment V2. Thus, the first and second conveying screws 12b and 12c disposed in the first and second developer compartments V1 and V2, respectively, circulate the developer inside the developer containing compartment partitioned by the partition 122.

The upstream end of the first developer compartment V1 in the developer conveyance direction communicates with a toner supply passage 123. The toner supply inlet 12e is disposed in the toner supply passage 123. Through the toner supply inlet 12e, fresh toner and the toner collected by the cleaning device 14 are supplied. The first conveying screw 12b disposed in the first developer compartment V1 extends into the toner supply passage 123. The first developer compartment VI communicate with the toner supply passage 123 through a communication opening 123a. The toner supplied from the toner supply inlet 12e is transported by the first conveying screw 12b inside the toner supply passage 123 and transported to the first developer compartment V1 through the communication opening 123a. The toner concentration sensor 124 detects the toner concentration of the developer. The toner concentration sensor 124 detects the toner concentration from the bottom (either inner bottom or outer bottom) of the first developer compartment V1 of the lower casing 1212.

FIG. 6 is a schematic cross-sectional view of the developing device 12.

The developing roller 12a according to the present embodiment includes the developing sleeve 12a2 and the magnet roller 12a1 (i.e., the magnetic field generator) stationarily disposed inside the developing sleeve 12a2. The magnet roller 12a1 in the present embodiment is columnar and made of a mixture of resin and magnetic powder, and the surface is subjected to magnetization treatment to have five magnetic poles P1 through P5. The magnetic pole P1 opposes the photoconductor 10 and hereinafter also referred to as “developing pole P1”. The magnetic pole P4 exerts a magnetic force to attract the developer from the second developer compartment V2. The magnetic pole PS opposes the developer doctor 12d and serves as a regulation pole (hereinafter also “regulation pole P5”). The magnetic pole P2 (hereinafter also “developer release pole P2”) and the magnetic pole P3, which are adjacent to each other in the direction of rotation of the developing roller 12a, are identical in polarity to each other and different in polarity from the magnetic pole P4. The magnetic poles P2 and P3 together generate a magnetic force to release the developer from the developing sleeve 12a2. Here, the position of each of the magnetic poles P1 through P5 is an angle position where the magnetic-flux density in the direction normal to the surface of the developing roller 12a (i.e., normal magnetic-flux density) reaches a peak. The developer leaves the developing sleeve 12a2 in a developer release range, which is located between positions where the normal magnetic-flux density of the magnetic poles P2 and P3 reach their peaks.

The magnetic pole P3 may be called a developer scooping pole, and the magnetic pole P4 may be called a conveyance pole. Alternatively, the magnetic pole P3 may be called a developer release pole, and the magnetic pole P4 may be called a developer scooping pole (in this case, the magnetic pole P2 may be called a conveyance pole or another release pole).

In the present embodiment, as illustrated in FIG. 6, the developer doctor 12d is rod-shaped and circular (or polygonal) in cross section perpendicular to the axial direction thereof. As the developer doctor 12d, a solid rod cut from a base material, subjected only to end-face treatment, can be used. Thus, the production cost can be low. Additionally, when the developer doctor 12d is press-fitted into the upper casing 1211, which supports the developing roller 12a rotatably, as illustrated in FIG. 4A, the positions of the developer doctor 12d and the developing roller 12a can be determined relative to an identical component (the upper casing 1211). Accordingly, the accumulation of dimensional tolerance can be kept minimum, and a doctor gap DG, which is a gap between the developing roller 12a and the developer doctor 12d, can be formed with a high degree of accuracy.

The carrier of the developer is not consumed but remains in the developing device. The carrier deteriorates over time while being used. Accordingly, the carrier is replaced regularly. If the developer containing compartment contains a large amount of developer, at replacement, a large amount of degraded carrier is discarded, which is a large environmental load. In the present embodiment, to alleviate the environmental load, the amount of the developer contained in the developer containing compartment is reduced. As the amount of the developer contained in the developer containing compartment decreases, the weight of the developing device decreases, and the energy to transport the device is reduced. Additionally, the load of rotation of the first and second conveying screws decreases, thereby reducing the energy to operate the developing device. Thus, the environmental load can be reduced further.

Typically, however, as the amount of developer contained in the developer containing compartment is reduced, the amount of developer borne on the developing roller decreases, resulting in decreases in image density. Accordingly, the distance between the developing roller and the conveying screw is reduced, or the angle or strength of the magnetic pole inside the developing roller is changed so that the developing roller can bear a greater amount of developer. In this case, however, the developer that has left the developing roller is likely to follow the developing roller and is not collected in the developer containing compartment but is borne again onto the developing roller, which is hereinafter referred to as “re-scooping of developer” or “carry-over of developer”. According to the present embodiment, re-scooping of developer is inhibited to attain desirable images even when the amount of developer contained in the developer containing compartment is reduced.

Features of the present embodiment are described in below.

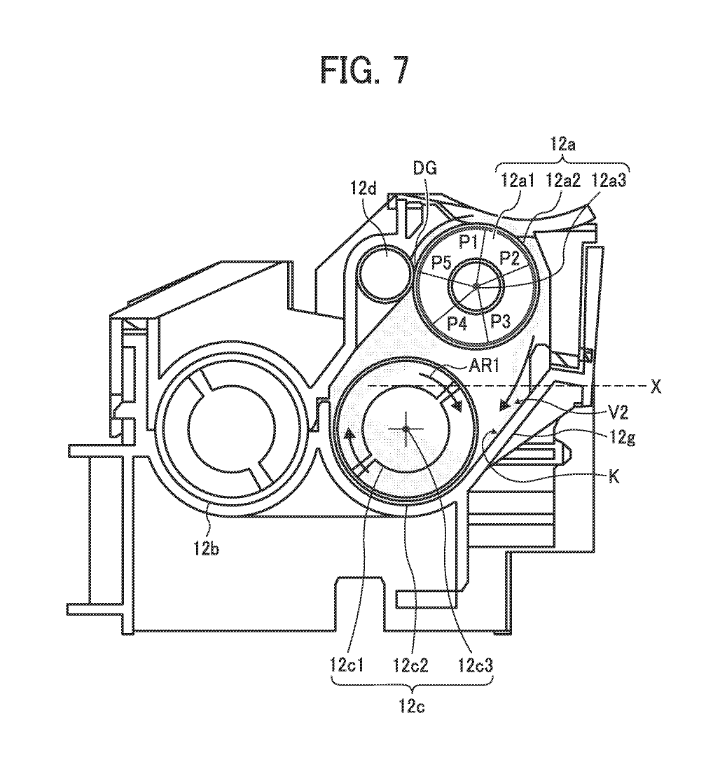

FIG. 7 is a schematic cross-sectional view of the developing device 12 according to the present embodiment.

As illustrated in FIG. 7, in the developing device 12 according to the present embodiment, as viewed in the axial direction of the second conveying screw 12c (i.e., on the cross section perpendicular to the axial direction thereof), an axis 12c3 (i.e., rotation center) of the second conveying screw 12c is shifted from an axis 12a3 of the developing roller 12a toward the magnetic pole P4 in a horizontal direction. Accordingly, a downward-rotation side (right side in FIG. 7) of the second conveying screw 12c is drawn away from the developer release range (between the peak positions of the normal magnetic-flux density of the magnetic poles P2 and P3). Then, an upward-rotation side (left side in FIG. 7) of the second conveying screw 12c is farther from the developer release range than the magnetic pole P4. With this arrangement, the upstream-rotation side of the second conveying screw 12c (i.e., the left side in FIG. 7, closer to the magnetic pole P4) is away from a position vertically below the developer release range, and the developer released in the developer release range is less likely to directly fall on the developer on the left side (closer to the magnetic pole P4, also “scooping side”) in the second developer compartment V2. Accordingly, this arrangement inhibits the occurrence of re-scooping of developer caused by the developer directly falling on the surface of the developer (on the side closer to the magnetic pole P4) in the second developer compartment V2.

Behavior of developer is described below with reference to FIG. 7. The developer is supplied from the second conveying screw 12c to the surface of the developing roller 12a, passes through the developing range, and leaves the developing roller 12a in the developer release range. The leaving developer falls to the second developer compartment V2 and is mixed with the developer contained in the second developer compartment V2. In FIG. 7, the developer is represented by hatching. The second conveying screw 12c and the developing roller 12a rotate clockwise in FIG. 7.

More specifically, in the rotation direction (indicated by arrow AR1 in FIG. 7) of the second conveying screw 12c, as the second conveying screw 12c rotates, in an upstream area (on the left in FIG. 7) from a top position X (i.e., height in rotation) of the shaft 12c1 of the second conveying screw 12c, the developer is lifted, and the level of the developer ascends. Hereinafter “upstream area (or downstream area) of the top position X” mean those in the rotation direction of the second conveying screw 12c unless otherwise specified. In a downstream area (on the right in FIG. 7) from the top position X of the shaft 12c1 of the second conveying screw 12c, the developer goes down, and the level of the developer descends. Accordingly, while the second conveying screw 12c rotates, the surface of the downstream area of the second conveying screw 12c from the top position X of the shaft 12c1 is not buried in the developer. It is to be noted that, while the second conveying screw 12c is not rotating, the level of the developer is higher on the left than on the right in FIG. 7, although the difference is reduced to a certain degree.

As the second conveying screw 12c rotates, in the upstream area from the top position X of the shaft 12c1 of the second conveying screw 12c, the developer is lifted toward the magnetic pole P4. Then, the developer is scooped onto the surface of the developing roller 12a due to the rotation force of the second conveying screw 12c and the magnetic force exerted by the magnetic pole P4. As the developing roller 12a rotates, the developer thereon is transported to a regulation area around the doctor gap DG, which is a clearance between the developing roller 12a and the developer doctor 12d. While the developer passes the doctor gap DG, an excess amount of developer is blocked. Subsequently, in the developing range facing the photoconductor 10, the toner in developer adheres to the latent image on the photoconductor 10. Downstream from the developing range, the developer not used in image developing leaves the developer release range and falls to the second developer compartment V2.

The developing device 12 in the present embodiment includes a guide 12g disposed vertically below the developer release range. The guide 12g guides the developer leaving the developer release range toward the second conveying screw 12c. The guide 12g is disposed below the developing roller 12a and includes an inclined face K inclined down toward the second conveying screw 12c. The developer leaving the developer release range falls on the inclined face K. Specifically, the developer directly falls on the inclined face K, which is disposed lower than the top position X of the shaft 12c1 and downstream (on the right in FIG. 7) from the top position X in the rotation direction of the second conveying screw 12c on the cross section illustrated in FIG. 7 perpendicular to the axial direction of the second conveying screw 12c. That is, the developer that has left the developer release range does not directly contact a spiral blade 12c2 of the second conveying screw 12c. Thus, the inclined face K, which is inclined down to the second conveying screw 12c, receives the developer falling down from the developer release range. Then, the developer moves along the inclined face K to a range of reach of the spiral blade 12c2 of the second conveying screw 12c. The developer release range is a range between the magnetic poles P2 and P3, which are adjacent to each other and identical in polarity, and is located on the side where the rotation of the developing roller 12a is downward. Accordingly, the developer that has left the developer release range can be mixed with the developer contained in the second developer compartment V2.

Further, in the present embodiment, it is preferable that the amount of developer transported in the second developer compartment V2 is such an amount that the shaft 12c1 of the second conveying screw 12c is not buried in the developer while the second conveying screw 12c rotates. With such an amount of developer, when the second conveying screw 12c rotates, a top portion of the shaft 12c1 is exposed above the surface of the developer in the second developer compartment V2. That is, the shaft 12c1 divides an upper portion of the developer in the second developer compartment V2 to the right and the left in FIG. 7. As a result, the shaft 12c1 of the second conveying screw 12c can inhibit the developer from moving from the downward-rotation side of the second conveying screw 12c (closer to the developer release range) to the upward-rotation side (closer to the magnetic pole P4) of the second conveying screw 12c. Accordingly, this arrangement inhibits the occurrence of re-scooping of developer, caused by the developer moving along the surface of the developer in the second developer compartment V2 to the upward-rotation side of the second conveying screw 12c (closer to the magnetic pole P4).

Next, descriptions are given below of an example of the present embodiment (i.e., Embodiment 1) and Comparative examples 1, 2, and 3.

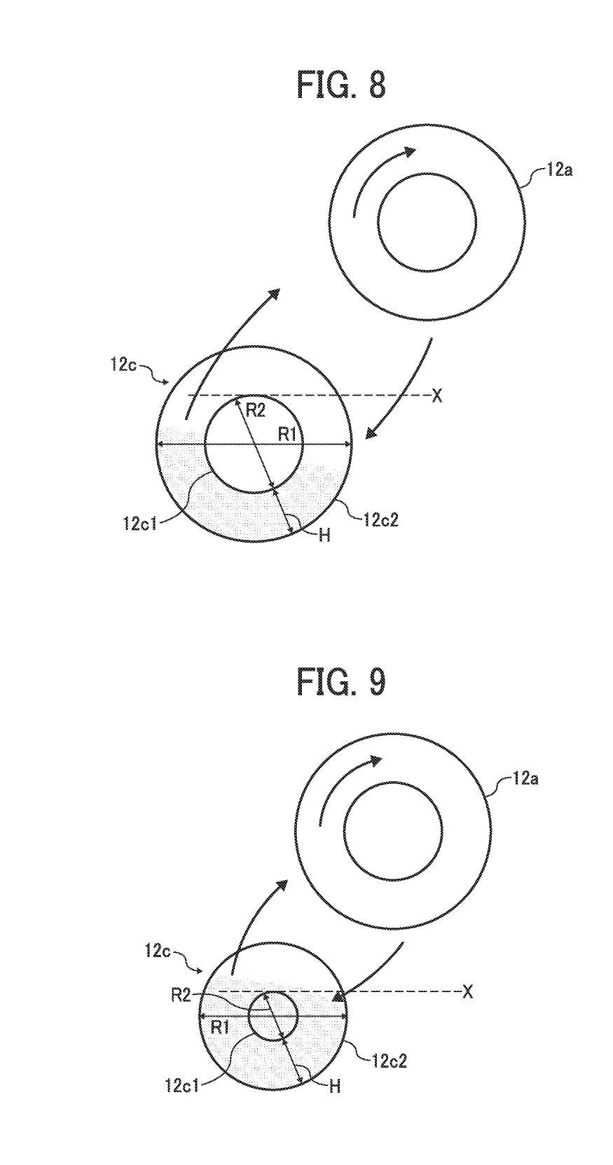

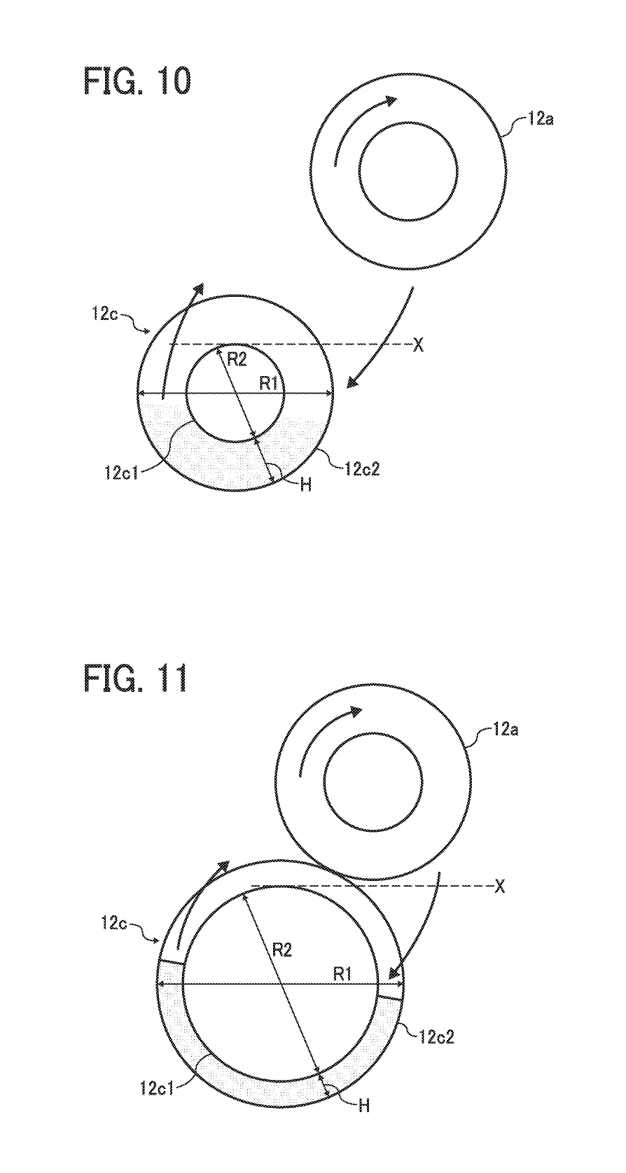

FIG. 8 is a partial cross-sectional view illustrating an arrangement of the developing roller 12a and the second conveying screw 12c according to Embodiment 1, FIG. 9 is a partial cross-sectional view illustrating an arrangement of the developing roller 12a and the second conveying screw 12c according to Comparative Example 1. FIG. 10 is a partial cross-sectional view illustrating an arrangement of the developing roller 12a and the second conveying screw 12c according to Comparative example 2. FIG. 11 is a partial cross-sectional view illustrating an arrangement of the developing roller 12a and the second conveying screw 12c according to Comparative example 3.

In Embodiment 1 illustrated in FIG. 8, a blade outer diameter R1, which is the trajectory of an external end (an outermost end) of the spiral blade 12c2 of the second conveying screw 12c, is 17 mm, a shaft diameter R2, which is an outer diameter of the shaft 12c1, is 11 mm, a blade height H, which is the height from the surface (i.e., cylindrical surface) of the shaft 12c1 to the external end of the spiral blade 12c2, is 3 mm. In this structure, the percentage of the shaft diameter R2 to the blade outer diameter R1 of the second conveying screw 12c is 65%.

In Comparative Example 1 illustrated in FIG. 9, the blade outer diameter R1 is 12 mm, the shaft diameter R2 is 6 mm, and the blade height H is 3 mm. The properties and the amount of developer and the developing roller 12a used in Comparative Example 1 are similar to Embodiment 1. In this structure, the percentage of the shaft diameter R2 to the blade outer diameter R1 of the second conveying screw 12c is 50%. In Comparative Example 1, the second conveying screw 12c and the second developer compartment V2 enclosing the second conveying screw 12c are designed such that the distance from the developing roller 12a to the surface of the developer is identical to that in Embodiment 1. Accordingly, poor scooping of developer does not occur. However, the level of developer in the second developer compartment V2 becomes higher than the shaft 12c1 of the second conveying screw 12c, and the developer that has left the developer release range enters the range affected by the magnetic force of the magnetic pole P4. Then, re-scooping of developer occurs, and image density becomes uneven.

Further, in a case where the magnetic pole P3 (the downstream one of two adjacent poles having an identical polarity) is disposed downstream from the position illustrated in FIG. 7 (that is, downstream from a lowest position of the developing roller 12a) in the rotation direction of the developing roller 12a, when the developing roller 12a rotates at a high speed, developer that has left the developer release range falls on the developer in the area upstream from the top position X in the rotation direction of the shaft 12c1 (on the left side of the second conveying screw 12c in FIG. 9). Then, the falling developer can be scooped onto the developing roller 12a, making the image density uneven. Therefore, as described above, it is preferable that, during the rotation of the second conveying screw 12c, at least the downstream portion (throughout in the axial direction) of the shaft 12c1 from the top position X is not buried in the developer but is exposed.

In Comparative example 2 illustrated in FIG. 10, the blade outer diameter R1 is 17 mm, the shaft diameter R2 is 7 mm, and the blade height H is 5 mm. The properties and the amount of developer and the developing roller 12a used in Comparative example 2 are similar to Embodiment 1. In this structure, the percentage of the shaft diameter R2 to the blade outer diameter R1 of the second conveying screw 12c is 41%. in Comparative example 2, the height of the second conveying screw 12c buried in the developer descends, thereby inhibiting re-scooping of developer. The level of developer, however, is lowest when the toner concentration is at a lower limit of allowable range. Accordingly, developer was not sufficiently scooped, resulting in partial absence of toner (while void) in an image.

In Comparative example 3 illustrated in FIG. 11, the blade outer diameter R1 is 22 mm, the shaft diameter R2 is 18 mm, and the blade height H is 2 mm. The properties and the amount of developer and the developing roller 12a used in Comparative example 2 are similar to Embodiment 1. In this structure, the percentage of the shaft diameter R2 to the blade outer diameter R1 of the second conveying screw 12c is 83%. In Comparative example 3, the blade height H is 2 mm, which is lower compared with Embodiment 1 and Comparative Example 1 or 2. Accordingly, the amount of developer borne on the developing roller 12a, due to the rotation of the second conveying screw 12c and the magnetic force exerted by the magnetic pole P4, is smaller. Thus, scooping of developer was insufficient. Additionally, since the external end of the spiral blade 12c2 of the second conveying screw 12c is closer to the developing roller 12a, the spiral blade 12c2 scrapes off the developer from the developing roller 12a, causing unevenness corresponding to the screw-blade pitch of the second conveying screw 12c (hereinafter “uneven image density corresponding to screw pitch”). The conditions, scooping capability, evaluation of re-scooping of developer of Embodiment 1 and Comparative examples 1 through 3 are summarized in Table 1. In Table 1, Regarding evaluation of re-scooping, the rating “good” represents that re-scooping of developer did not occur, and the rating “poor” represents that re-scooping of developer occurred. According to the results of the evaluation, it is preferable that the shaft diameter R2 is greater than or equal to 55% of the blade outer diameter R1 and the blade height H is greater than or equal to 3 mm.

TABLE 1

| | Embodiment | Comparative | Comparative | Comparative |
|---|---|---|---|---|
| Conditions | 1 | example 1 | example 2 | example 3 |
| blade outer | 17 | 12 | 17 | 22 |
| diameter R1 | | | | |
| shaft diameter | 11 | 6 | 7 | 18 |
| R2 | | | | |
| blade height H | 65 | 50 | 41 | 82 |
| Percentage of | 3 | 3 | 5 | 2 |
| R2 to R1 | | | | |
| Scooping | Good | Good | Poor | Poor |
| capability | | | | |
| Inhibition of | Good | Poor | Good | Good |
| rescooping | | | | |

Next, descriptions are given below of a method of determining the upper and lower limits of the blade outer diameter R1 of the second conveying screw 12c from the shaft diameter R2 and the blade height H of the second conveying screw 12c and the like.

The lower limit of the blade outer diameter R1 of the second conveying screw 12c is geometrically determined as 13.3 mm. By contrast, the upper limit of the blade outer diameter R1 of the second conveying screw 12c is set in a range in which the defective scooping of developer and uneven image density corresponding to screw pitch do not occur. As the blade outer diameter R1 of the second conveying screw 12c is increased, eventually the second conveying screw 12c contacts the developing roller 12a. The arrangement in which the second conveying screw 12c contacts the developing roller 12a is not adaptable since the image density becomes uneven corresponding to the screw pitch. Then, the blade outer diameter R1 is increased while the position of the shaft of the second conveying screw 12c is lowered. However, the distance between the surface of developer and the developing roller 12a increases, resulting in defective scooping of developer. To inhibit increases in the distance between the surface of developer and the developing roller 12a, the shaft diameter R2 is increased to raise the level of developer. Although the blade height H is preferably greater than or equal to 3 mm, there is an upper limit to the shaft diameter R2. The upper limit of shaft diameter R2 is determined from the amount of developer contained in the second developer compartment V2.

The various aspects of the present specification can attain specific effects as follows.

Aspect A

Aspect A concerns a developing device (12) that includes a developer containing compartment (e.g., the second developer compartment V2) to contain developer, a developer bearer (e.g., the developing roller 12a) to bear developer, disposed opposite an image bearer (e.g., the photoconductor 10) and having adjacent magnetic poles (e.g., magnetic poles P2 and P3) adjacent to each other and identical in polarity, and a developer conveyor such as a conveying screw (e.g., the second conveying screw 12c) including a shaft (e.g., the shaft 12c1). The developer conveyor is disposed lower than the developer bearer and in the developer containing compartment. While rotating, the developer conveyor supplies the developer to the surface of the developer bearer and collects the developer that has passed a developing range opposing the image bearer. The adjacent magnetic poles identical in polarity are disposed downstream from the developing range in the rotation direction of the developer bearer, Further, the adjacent magnetic poles are disposed on a downward-rotation side where the surface of the developer bearer moves downward. Vertically below the adjacent magnetic poles identical in polarity, an inclined face, which is inclined down toward the developer conveyor, is disposed.

In Aspect A, since the adjacent magnetic poles identical in polarity are disposed on the downward-rotation side of the developer bearer, the developer is reliably separated from the developer bearer and falls to the developer conveyor. Since the developer conveyor does not hinder the developer from falling thereto, re-scooping of developer is inhibited. Accordingly, uneven image density is inhibited.

Aspect B

In Aspect A, the level of the developer contained in the developer containing compartment is lower than a top position (X) of the shaft (12c1) of the developer conveyor (the second conveying screw 12c) such that the shaft is partially exposed from the developer when the developer conveyor is not rotating.

According to this aspect, while the conveying screw serving as the developer conveyor is not rotating, the developer in the developer containing compartment is divided by the shaft of the conveying screw. As a result, the shaft of the conveying screw can inhibit the developer on the downward-rotation side (closer to the developer release range) of the conveying screw from flowing to the upward-rotation side (farther from the developer release range) of the conveying screw. If the developer flows to the upward-rotation side (closer to the magnetic pole P4), re-scooping of developer occurs. However, this aspect can inhibit re-scooping of developer.

Aspect C

In Aspect B, the inclined face (K) is disposed lower than the top position (X) of the shaft of the developer conveyor.

According to this aspect, the developer that has left the developer release range is caused to fall on the inclined face lower than the top position of the shaft of the conveying screw. Then, the shaft of the conveying screw serves as a wall to block the developer from flowing to the upward-rotation side (closer to the magnetic pole P4) of the conveying screw.

Accordingly, the developer that has left the developer release range can be guided down to the conveying screw and mixed with the developer contained in the developer containing compartment.

Aspect D

In any one of Aspects A through C, the percentage of the shaft diameter (R2) of the developer conveyor to the trajectory drawn by the external end of the blade is not smaller than 55%, and the blade height, which is the height from the surface of the shaft of the developer conveyor to the external end of the blade, is not smaller than 3 mm.

If the blade height of the conveying screw is smaller than 3 mm, the conveying screw may fail to sufficiently stir and mix the developer. Accordingly, the shaft is preferably made thicker to the extent that the blade height is kept at 3 mm or greater. Additionally, with the feature that the shaft diameter occupies 55% or more of the blade outer diameter (e.g., the trajectory drawn by the external end of the blade), desirable image quality can be attained even when the amount of developer contained in the device is reduced. The reduction in developer amount attains resource saving, energy saving in transport due to weight reduction of the device, and energy saving in operation due to reduction of load of the conveying screw.

Aspect E

A process cartridge includes, at least, a latent image bearer (e.g., the photoconductor 10) and the developing device according to any one of Aspects A through D, and the developing device is united together with the latent image bearer. The process cartridge is configured to be removably mounted in an image forming apparatus.

According to this aspect, the process cartridge can inhibit the above-described uneven image density caused by re-scooping of developer and produce desirable images.

Aspect F

An image forming apparatus includes a latent image bearer and the developing device according to any one of Aspects A through.

According to this aspect, the above-described uneven image density caused by re-scooping of developer is inhibited, and desirable images are produced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A developing device comprising:
a developer bearer having adjacent magnetic poles adjacent to each other and identical in polarity, the developer bearer to bear developer,
the adjacent magnetic poles disposed on a downward-rotation side where a surface of the developer bearer moves downward;
a developer containing compartment to contain developer;
a developer conveyor including a shaft and disposed in the developer containing compartment, the developer conveyor to rotate to supply the developer to the surface of the developer bearer and collect the developer downstream, in a rotation direction of the developer bearer, from a developing range opposing a latent image bearer; and
an inclined face disposed vertically below the adjacent magnetic poles, the inclined face inclined down toward the developer conveyor.

2. The developing device according to claim 1, wherein a level of the developer contained in the developer containing compartment is lower than a top position of the shaft of the developer conveyor such that the shaft is partially exposed from the developer when the developer conveyor is not rotating.

3. The developing device according to claim 2, wherein the inclined face is disposed lower than the top position of the shaft of the developer conveyor.

4. The developing device according to claim 1, wherein the developer conveyor includes a blade attached to the shaft,
wherein, in the developer conveyor, a percentage of an outer diameter of the shaft to a trajectory drawn by an external end of the blade is not smaller than 55%, and
wherein a height from a surface of the shaft of the developer conveyor to the external end of the blade is not smaller than 3 mm.

5. A process cartridge to be removably mounted in an image forming apparatus, the process cartridge comprising:
the latent image bearer to bear a latent image;
the developing device according to claim 1 to develop the latent image with the developer; and
a frame to support the latent image bearer and the developing device as a unit.

6. An image forming apparatus comprising:
a latent image bearer to bear a latent image; and
the developing device according to claim I to develop a latent i re on the latent image bearer with the developer.
